(19) United States
(12) Patent Application Publication
(10) Pub. No.: US 2015/0055384 A1
(43) Pub. Date: Feb. 26, 2015

(54) Five-Level Four-Switch DC-AC Converter

(71) Applicant: Indiana University Research & Technology Corporation, Indianapolis, IN (US)

(72) Inventors: Euzeli dos Santos, Indianapolis, IN (US); Lucas Hartmann, Joao Pessoa (BR)

(21) Appl. No.: 14/465,289

(22) Filed: Aug. 21, 2014

Related U.S. Application Data
(60) Provisional application No. 61/868,393, filed on Aug. 21, 2013.

(51) Int. Cl. H02M 7/537

(52) U.S. Cl. CPC H02M 7/537
USPC 363/131

(57) ABSTRACT

A single-phase DC-AC converter generates an AC voltage with five levels at the output converter side by using four controlled power switches. The converter has a relationship between the number of levels per number of switches (nL/nS) of five to four. The converter reduces the number of semiconductor devices required to generate a high number of levels at the output converter side, requires only one DC source to generate an AC output, and operates with high efficiency.

### CLAIM OF PRIORITY

This application claims priority to U.S. Provisional Application No. 61/868,393, which is entitled “Five-Level Four-Switch DC-AC Converter,” and was filed on Aug. 21, 2013, the entire contents of which are hereby incorporated by reference herein.

### TECHNICAL FIELD

The present description generally relates to electrical power conversion systems including systems that convert direct current (DC) voltages to alternating current (AC) voltages.

### BACKGROUND

Inverter circuits are known to the art for the conversion of a DC voltage to an output AC voltage. Inverters that convert a DC source to an AC voltage with multiple output levels are of interest to a wide range of applications, including low-power applications. Existing inverter circuits that are configured to generate multiple output levels often require a large number of switching transistors and other components including, but not limited to, capacitors and transformers to generate an AC voltage from a DC input source. FIG. 5 depicts examples of prior art converters that generate a five-level voltage for a single-phase output. The number of levels per number of switches (nL/nS) for the prior art configurations are given by 5/8 and 5/6. An improved inverter circuit that generates multi-level AC output voltages in an efficient manner would be beneficial to improve quality of the output voltage and efficiency of the inverter circuit.

### SUMMARY

A single-phase DC-AC converter is configured to generate an AC output voltage with five levels at the output converter side. An illustrative embodiment of the converter that is depicted in FIG. 1 includes an optimized relationship between the number of levels per number of switches: nL/nS=5/4. Besides the nL/nS, the converter also includes a reduced number of semiconductor devices while maintaining a high number of levels at the output converter side, only requires one DC source without any need to balance the capacitor voltages, and operates with high efficiency.

In one embodiment a power converter generates an AC output voltage from a DC voltage. The power converter includes a first switching device with a first terminal electrically connected to a first terminal of a split-wound coupled inductor and with a second terminal configured to be connected to a direct current (DC) voltage source, a second switching device with a first terminal electrically connected to a second terminal of the split-wound coupled inductor and with a second terminal configured to be connected to the direct current (DC) voltage source, a third switching device with a first terminal electrically connected to the second terminal of the first switching device and with a second terminal configured to be connected to a load, a fourth switching device with a first terminal electrically connected to the second terminal of the second switching device and with a second terminal configured to be connected to the load, and a controller operatively connected to the first switching device, second switching device, third switching device, and fourth switching device. The controller is configured to operate the first switching device, second switching device, third switching device, and fourth switching device to generate an alternating current (AC) output voltage that is supplied to the load through the second terminals of the third switching device and the fourth switching device and through a third terminal of the split-wound coupled inductor.

### BRIEF DESCRIPTION OF THE DRAWINGS

FIG. 1 is a schematic diagram of a converter circuit that generates an AC output voltage with five levels using four switching elements.

FIG. 2 is a set of schematic diagrams that depict a portion of the circuit of FIG. 1 in different operating modes.

FIG. 3 is a schematic diagram depicting pulse with modulation (PWM) controls for operating switching elements in the circuit of FIG. 1 and FIG. 2.

FIG. 4 is a set of graphs depicting simulated and measured results for DC to AC inversion using the circuit of FIG. 1 and FIG. 2.

FIG. 5 is a set of schematic diagrams for prior art inverter circuits.

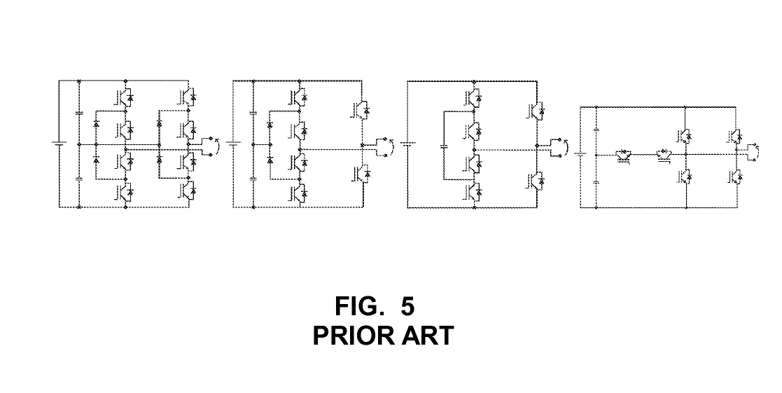

### DETAILED DESCRIPTION

For a general understanding of the environment for the system and method disclosed herein as well as the details for the system and method, reference is made to the drawings. In the drawings, like reference numerals have been used throughout to designate like elements.

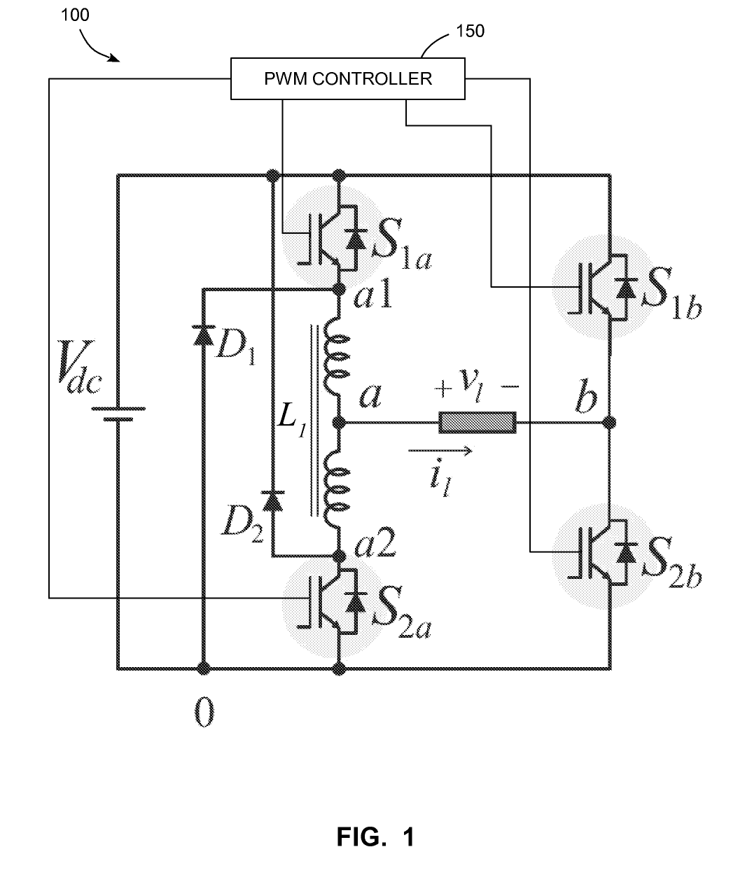

Referring to FIG. 1, a converter circuit 100 includes four switching power devices (S₁ₐ, S₂ₐ, S_{1b}, and S_{2b}), two diodes (D₁ and D₂) and one split-wound coupled inductor (L₁). The switching device S₁ₐ has a first terminal that is connected to a first terminal a₁ in the split-wound coupled inductor L₁ and a second terminal connected to a DC voltage source V_{dc}. The switching device S₂ₐ has a first terminal that is connected to a second terminal a₂ in the split-wound coupled inductor L₁ and a second terminal connected to the DC voltage source V_{dc}. The third switching device S_{1b} has a first terminal that is connected to the second terminal of the first switching device S₁ₐ and a second terminal that is connected to a load Vₗ. The fourth switching device S_{2b} has a first terminal that is connected to the second terminal of the second switching device S₂ₐ and a second terminal that is connected to the load υₗ. The split-wound coupled inductor Lᵢ has a third terminal a that is between the windings connected to the terminals a1 and a2. The third terminal a is connected to the load υₗ. The diode D₁ includes a cathode that is connected to the first terminal of the first switching device S₁ₐ and an anode that is connected to the DC voltage source V_{dc}. The diode D₂ includes an anode that is connected to the first terminal of the second switching device S₂ₐ and a cathode that is connected to the DC voltage source V_{dc}.

In one embodiment the switching power devices S₁ₐ, are controlled power transistors, such as metal oxide field effect transistors (MOSFETs), insulated gate bipolar transistors (IGBTs) and bipolar junction transistors (BJTs). In the description below, the state of the switches is represented by a binary variable, where Sⱼ=0 means an open switch and Sⱼ=1 means a closed switch (with j=1a, 2a, 1b and 2b). As described in more detail below, the switching devices S₁ₐ, S₂ₐ, S_{1b}, and S_{2b} are closed and opened using pulse width modulation (PWM) control signals to enable the circuit 100 to generate an AC output voltage from the DC voltage that is supplied by the DC source V_{dc}. FIG. 1 depicts a PWM controller 150 that is operatively connected to the switching devices S₁ₐ, S₂ₐ, S_{1b}, and S_{2b}. In an embodiment where the switching devices S₁ₐ, S₂ₐ, S_{1b}, and S_{2b} are transistors, the PWM controller 150 generates signals that control the base or gate of the transistors to switch the transistors on and off.

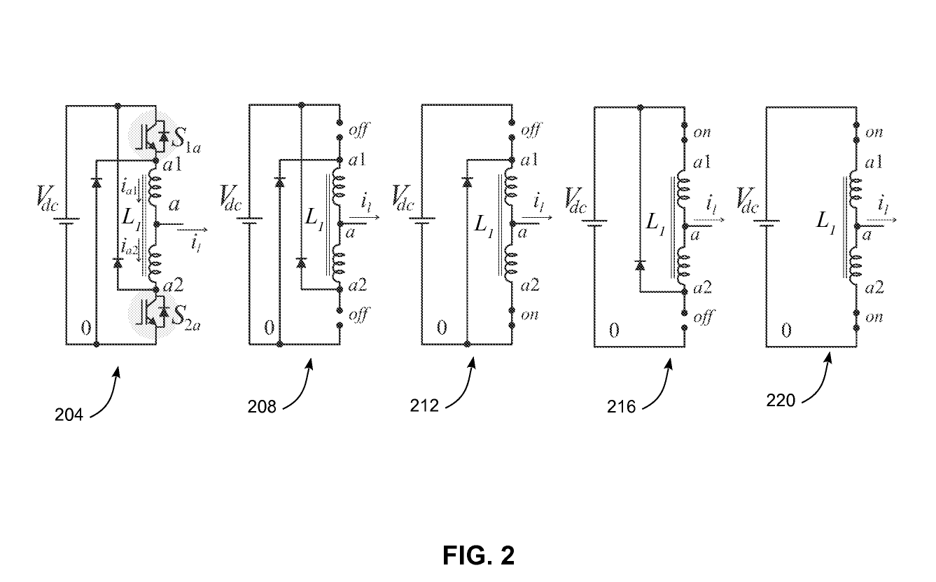

FIG. 2 depicts different configurations of the switching devices S₁ₐ and S₂ₐ from the circuit 100 of FIG. 1. The circuit configuration 204 depicts a continuous conduction mode through the coupled-windings L₁. The circuit configuration 208 depicts a configuration where the switching devices S₁ₐ and S₂ₐ are both open (0-0). The circuit configuration 212 depicts a configuration where the switching device S₁ₐ is open and the switching device and S₂ₐ is closed (0-1). The circuit configuration 216 depicts a configuration where the switching device S₁ₐ is closed and the switching device and S₂ₐ is open (1-0). The circuit configuration 220 depicts a configuration where the switching devices S₁ₐ and S₂ₐ are both closed (1-1).

In the circuit configurations of FIG. 1 and FIG. 2, the voltages υₐ₁₀ and υₐ₂₀ (voltages from the nodes a1 and a2 to zero) can be expressed as a function of the state of the switching devices with the following equations:

υₐ₁₀=S₁ₐV_{dc}

υₐ₂₀=(1−S₂ₐ)V_{dc}

Similarly, the voltage υ_{b0} is the voltage from node b to zero and is expressed with the following equation: υ_{b0}=S_{1b}V_{dc}, where S_{1b}=1−S_{2b}, where the switches S_{1b} and S_{2b} are operate in a complementary configuration to avoid a short circuit of the DC source.

In the circuit 100, the voltage υₐ₀ is provided by the following equation:

$${v}_{a 0} = \frac{1}{2} ( {v}_{a 10} + {v}_{a 20} )$$

The load voltage υₗ, which is the AC output voltage that is delivered to a load, is determined using υₐ₀ and υ_{b0} using the following equation:

υₗ=υₐ₀−υ_{b0}.

Table 1 lists different voltages of the converter circuit when the switching devices are in different states. The AC voltage that is generated at the converter output has five different levels (V_{dc}, V_{dc}/2, 0, −V_{dc}/2, −V_{dc}).

TABLE 1
Load Voltage as a Function of Switching State

| S₁ₐ | S₂ₐ | S_{1b} | S_{2b} | vₐ₁₀ | vₐ₂₀ | vₐ₀ | v_{b0} | v_{ind} | vₗ |
|---|---|---|---|---|---|---|---|---|---|
| 0 | 0 | 0 | 1 | 0 | V_{dc} | V_{dc}/2 | 0 | −V_{dc} | V_{dc}/2 |
| 0 | 0 | 1 | 0 | 0 | V_{dc} | V_{dc}/2 | V_{dc} | −V_{dc} | −V_{dc}/2 |
| 0 | 1 | 0 | 1 | 0 | 0 | 0 | 0 | 0 | 0 |
| 0 | 1 | 1 | 0 | 0 | 0 | 0 | V_{dc} | 0 | −V_{dc} |
| 1 | 0 | 0 | 1 | V_{dc} | V_{dc} | V_{dc} | 0 | 0 | V_{dc} |
| 1 | 0 | 1 | 0 | V_{dc} | V_{dc} | V_{dc} | V_{dc} | 0 | 0 |
| 1 | 1 | 0 | 1 | V_{dc} | 0 | V_{dc}/2 | 0 | V_{dc} | V_{dc}/2 |
| 1 | 1 | 1 | 0 | V_{dc} | 0 | V_{dc}/2 | V_{dc} | V_{dc} | −V_{dc}/2 |

In the circuit 100, the split-wound coupled inductor L₁ is operated in a continuous conduction mode. The voltage level υ_{ind} in the split-wound coupled inductor L₁ is provided by the following equation:

υ_{ind}=υₐ₁₀−Vₐ₂₀.

As depicted in Table 1, the modulation parameters for operating the switching device S_{1b} are defined with the following rules: (i) S_{1b}=1 if υₗ*<0 and S_{1b}=0 if υₗ*≧0. The leg b in the circuit 100 operates at the frequency of the output AC load (e.g. 50 Hz or 60 Hz for many electrical grids), and the comparatively low frequency of the switching leg b reduces the switching losses in the circuit 100.

During operation of the circuit 100, the signals that control the operation of the switching devices S₁ₐ, S₂ₐ, S_{1b}, and S_{2b} produce an average load voltage υₗ* and average inductor voltage υ_{ind}* are characterized by the following instantaneous time equations:

$${v}_{l}^{*} = {S}_{1 a} \frac{{V}_{dc}}{2} + ( 1 - {S}_{2 a} ) \frac{{V}_{dc}}{2} - {S}_{1 b} {V}_{dc}$$

$${v}_{ind}^{*} = {S}_{1 a} {V}_{dc} - ( 1 - {S}_{2 a} ) {V}_{dc}$$

The previous equations are instantaneous time equations that describe the states of the switching devices S₁ₐ and S₂ₐ at single point in time. To control the circuit over time, a controller operates the switching devices using a pulse width modulation (PWM) control scheme in which each of the switching devices S₁ₐ, S_{1b}, S₂ₐ, S_{2b} are switched between closed and opened states with duty cycles of d₁ₐ, d₂ₐ, d_{1b}, and d_{2b}, respectively. As described above, the PWM cycles for the transistors S_{1b} and S_{2b} are complementary where S_{1b} is closed whenever S_{2b} is opened, and vice-versa. The duty cycles for each of the switching devices are described in the following equations:

$${d}_{1 a} = \frac{1}{{T}_{s}} {\int }_{t}^{t + {T}_{s}} {S}_{1 a} ( t ) d t$$

$${d}_{2 a} = \frac{1}{{T}_{s}} {\int }_{t}^{t + {T}_{s}} {S}_{2 a} ( t ) d t$$

$${d}_{1 b} = \frac{1}{{T}_{s}} {\int }_{t}^{t + {T}_{s}} {S}_{1 b} ( t ) d t$$

$${d}_{2 b} = \frac{1}{{T}_{s}} {\int }_{t}^{t + {T}_{s}} {S}_{2 b} ( t ) d t = 1 - {d}_{1 b}$$

The following equations describe the average load voltage υₗ* and average inductance voltage υ_{ind}* in conjunction with the duty cycles:

$$\frac{2 {v}_{l}^{*}}{{V}_{dc}} = {d}_{1 a} + 1 - {d}_{2 a} - 2 {d}_{1 b}$$

$$\frac{{v}_{ind}^{*}}{{V}_{dc}} = {d}_{1 a} + {d}_{2 a} - 1$$

The terms d₁ₐ and d₂ₐ from the preceding equations are expressed in the following equations:

$${d}_{1 a} = \frac{{v}_{ind}^{*} + 2 {v}_{l}^{*}}{2 {V}_{dc}} + {S}_{1 b}$$

$${d}_{2 a} = \frac{{v}_{ind}^{*} + 2 {v}_{l}^{*}}{2 {V}_{dc}} + ( 1 - {S}_{1 b} )$$

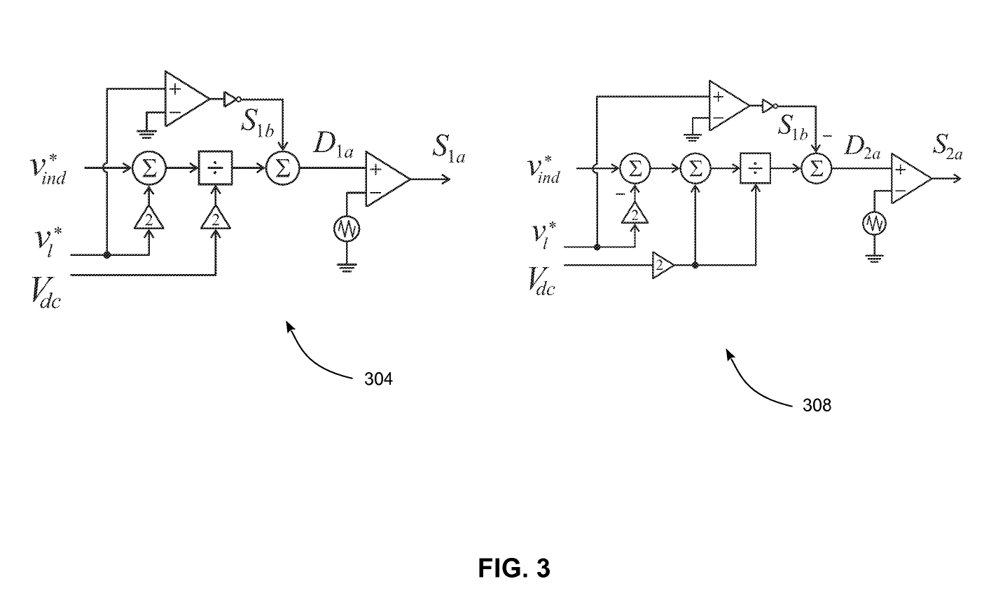

In the circuit 100, the controller 150 is operatively connected to the power switching devices S₁ₐ, S₂ₐ, S_{1b}, and S_{2b} to switch the devices on (closed switch) and off (opened switch) into the states that are depicted in Table 1. In one embodiment, the controller 150 generates the PWM signals that control the base or gate of the power transistors S₁ₐ, S₂ₐ, S_{1b}, and S_{2b} to switch the transistors on and off FIG. 3 depicts schematic diagrams 304 and 308 of circuits that are implemented in the controller 150 to generate the PWM control signals. The control circuits 304 and 308 generate PWM control signals with duty cycles that correspond to the equations listed above for d₁ₐ, d₂ₐ, d_{1b}, and d_{2b}. The controller 150 implements the functionality that is depicted in the schematic circuits 304 and 308 using, for example, discrete analog and digital circuit components, or as stored program instructions that are executed by a microcontroller or other appropriate digital processor.

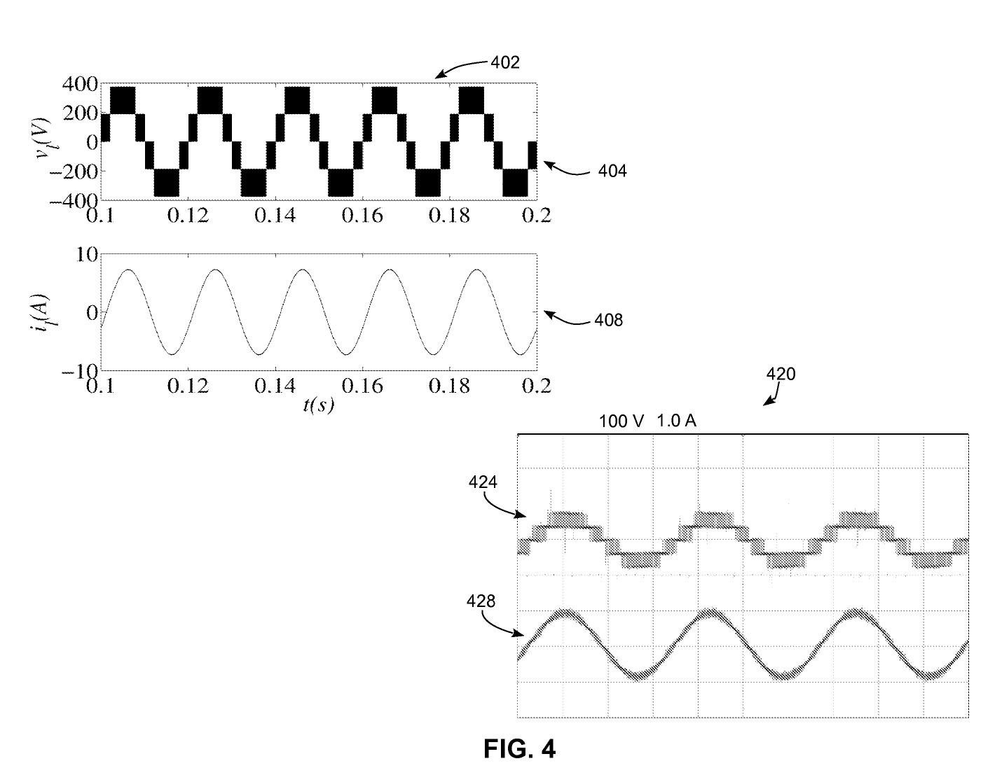

FIG. 4 depicts a graph 402 of simulated results including a simulated AC output voltage waveform 404 and output current waveform 408. The graph 420 depicts measured output waveforms from an embodiment of the circuit 100 including a measured AC output voltage waveform 424 and measured AC output waveform 428. The measured AC output waveform 428 is formed in a sinusoidal AC output waveform at the predetermined AC output voltage frequency with the five discrete output voltage levels that are described above in Table 1. In the illustrative example of FIG. 4, the DC voltage level is 400V, and the measured AC output voltage swings between +400V and −400V with the sinusoidal output waveform at the predetermined AC waveform frequency. As depicted in FIG. 4, the output voltage of the AC voltage has five voltage levels from the positive peak voltage amplitude to the negative peak voltage amplitude.

While the embodiments have been illustrated and described in detail in the drawings and foregoing description, the same should be considered as illustrative and not restrictive in character. The reader should understand that only the preferred embodiments have been presented and that all changes, modifications and further applications that come within the spirit of the scope of the claims presented below are desired to be protected.

What is claimed is:

1. A power converter comprising:
a first switching device with a first terminal electrically connected to a first terminal of a split-wound coupled inductor and with a second terminal configured to be connected to a direct current (DC) voltage source;
a second switching device with a first terminal electrically connected to a second terminal of the split-wound coupled inductor and with a second terminal configured to be connected to the direct current (DC) voltage source;
a third switching device with a first terminal electrically connected to the second terminal of the first switching device and with a second terminal configured to be connected to a load;
a fourth switching device with a first terminal electrically connected to the second terminal of the second switching device and with a second terminal configured to be connected to the load; and
a controller operatively connected to the first switching device, second switching device, third switching device, and fourth switching device, the controller being configured to:
operate the first switching device, the second switching device, the third switching device, and the fourth switching device to generate an alternating current (AC) output voltage that is supplied to the load through the second terminals of the third switching device and the fourth switching device and through a third terminal of the split-wound coupled inductor.

2. The power converter of embodiment 1, the controller being further configured to:
generate a first pulse-width modulated signal to operate the first switching device;
generate a second pulse-width modulated signal to operate the second switching device;
generate a third pulse-width modulated signal to operate the third switching device; and
generate a fourth pulse-width modulated signal to operate the fourth switching device.

3. The power converter of claim 2, the controller being further configured to:
generate the first pulse-width modulation signal and the second pulse-width modulation signal with reference to a state of the first switching device, a state of the second switching device, a voltage level of the DC voltage source, and a state of the third switching device.

4. The power converter of claim 2, the controller being further configured to:
generate the third pulse-width modulated signal to open and close the third switching device at a predetermined frequency corresponding to a frequency of the AC output voltage; and
generate the fourth pulse-width modulated signal to open and close the fourth switching device at the predetermined frequency, the controller generating the third pulse-width modulated signal and the fourth pulse-width modulated signal to close the third switching device when the fourth switching device is open and open the third switching device when the fourth switching device is closed.

5. The power converter of claim 1 further comprising:
a first diode with a cathode electrically connected to the second terminal of the first switching device and an anode configured to be electrically connected to the DC voltage source; and
a second diode with an anode electrically connected to the second terminal of the second switching device and a cathode configured to be electrically connected to the DC voltage source.

6. The power converter of claim 1, each of the first switching device and the second switching device being one of a metal oxide field effect transistor (MOSFET), insulated gate bipolar transistor (IGBT) and bipolar junction transistor (BJT).

7. The power converter of claim 1, the controller being further configured to:
operate the first switching device, the second switching device, the third switching device, and the fourth switching device to generate the AC output voltage at a predetermined frequency with a sinusoidal waveform having five discrete voltage levels.

8. A method of operating a power converter circuit to generate an alternating current (AC) output voltage from a direct current (DC) voltage source comprising:
generating with a controller a first control signal for a first switching device with a first terminal electrically connected to a first terminal of a split-wound coupled inductor and with a second terminal configured to be connected to a direct current (DC) voltage source;
generating with the controller a second control signal for a second switching device with a first terminal electrically connected to a second terminal of the split-wound coupled inductor and with a second terminal configured to be connected to the direct current (DC) voltage source;
generating with the controller a third control signal for a third switching device with a first terminal electrically connected to the second terminal of the first switching device and with a second terminal configured to be connected to a load; and
generating with the controller a fourth control signal for a fourth switching device with a first terminal electrically connected to the second terminal of the second switching device and with a second terminal configured to be connected to the load, the first, second, third, and fourth control signals operating the first, second, third, and fourth switching devices, respectively, to generate the AC output voltage for the load through the second terminals of the third switching device and the fourth switching device and through a third terminal of the split-wound coupled inductor.

9. The method of claim 8, the generation of the first control signal, the second control signal, the third control signal, and the fourth control signal further comprising:
generating with the controller a first pulse-width modulated signal to operate the first switching device;
generating with the controller a second pulse-width modulated signal to operate the second switching device;
generating with the controller a third pulse-width modulated signal to operate the third switching device; and
generating with the controller a fourth pulse-width modulated signal to operate the fourth switching device.

10. The method of claim 9, the generation of the first pulse-width modulated signal and the second pulse-width modulated signal further comprising:
generating with the controller the first pulse-width modulation signal and the second pulse-width modulation signal with reference to a state of the first switching device, a state of the second switching device, a voltage level of the DC voltage source, and a state of the third switching device.

11. The method of claim 9, the generation of the third pulse-width modulated signal and the fourth pulse-width modulated signal further comprising:
generating with the controller the third pulse-width modulated signal to open and close the third switching device at a predetermined frequency corresponding to a frequency of the AC output voltage; and
generating with the controller the fourth pulse-width modulated signal to open and close the fourth switching device at the predetermined frequency, the controller generating the third pulse-width modulated signal and the fourth pulse-width modulated signal to close the third switching device when the fourth switching device is open and open the third switching device when the fourth switching device is closed.

12. The method of claim 8 further comprising:
operating with the controller the first switching device, the second switching device, the third switching device, and the fourth switching device to generate the AC output voltage at a predetermined frequency with a sinusoidal waveform having five discrete voltage levels.
